(19) United States
(12) Patent Application Publication
(10) Pub. No.: US 2004/0030928 A1
(43) Pub. Date: Feb. 12, 2004

(54) Method and system for managing accessibility of the electronic address of a local terminal by one or several remote terminals

(76) Inventors: Thierry Catudal, Vern Sur Seiche (FR); Benoit Linot, Pleudihen Sur Rance (FR)

Correspondence Address: GARDNER CARTON & DOUGLAS LLP, 191 N. WACKER DRIVE, SUITE 3700, CHICAGO, IL, 60606, US

(21) Appl. No.: 10/415,183

(22) PCT Filed: Oct. 18, 2001
(86) PCT No.: PCT/FR01/03229

(30) Foreign Application Priority Data
Oct. 26, 2000 (FR) 00/13730

(51) Int. Cl. H04L 9/00

(52) U.S. Cl. 713/201

(57) ABSTRACT

The invention concerns a method and a system for managing accessibility of the electronic address of a local terminal (TL) by one or several remote terminals. The method consists in constituting (A) the set of electronic addresses (ADi) of the remote terminals (TDi) into at least one list (LI=[Adi]1N of parties of the user of the local terminal (TL), in subdividing (B) said set into separate groups (Gj) of electronic addresses and in assigning (C) to each of said groups (Gj) a privileged accessibility function (Fj), selected among a plurality of privileged accessibility functions with different degree of accessibility, to constitute groups of electronic addresses with distinct privileged accessibility (GAj). The invention is useful for managing accessibility of any type of terminals, terminals accessible through IP network and/or mobile radiotelephone terminals.

The invention relates to a method and a system for managing the accessibility of the electronic address of a local terminal of a user by one or more remote terminals, each furnished with an electronic address.

The proliferation of exchanges of messages by networked communication, exchange of email messages and/or of access or response messages following access to networked sites, such as extended networks such as the INTERNET network and/or as the case may be local networks or company networks, also referred to as INTRANET networks, is currently raising the crucial problem of the accessibility of any terminal by another terminal.

In particular, the concept of accessibility covers, on the one hand, the concept of actual availability of the user of this terminal, in relation to one or more users of other terminals, and, on the other hand, the concept of hardware and/or software compatibility of this terminal in relation to other terminals.

As far as the concept of actual availability of the user of this terminal is concerned, this concept covers the availability of this user in the light of his obligations, professional and/or personal, of relational criteria that this user wishes to establish in respect of his electronic messaging system, at the level of his terminal, in relation to certain of his counterparts, habitual or otherwise, who are apt to send and/or receive electronic messages to or from remote terminals each furnished with an electronic address. In the light of the qualifying as remote terminal of any terminal of a user the counterpart of this user, the terminal of the latter will be referred to as the local terminal in the present patent application when the distinction between local and remote terminal would appear to be necessary.

As far as the concept of compatibility, between terminals, local terminal/remote terminal, is concerned, the veritable explosion in the types of terminals on the market and available to users, in the light of their technical and/or functional characteristics, raises the problem of regard for the integrity of the messages received, or even of their actual reception.

Thus, a mobile telephony terminal can scarcely, at present, be regarded as capable of enabling the reception of electronic messages consisting of HTML pages accompanied by video files, unless provision is made to append means of display and of graphical interfacing.

The same holds, to a lesser degree however, in respect of electronic assistants, which, in relation to portable computers also known as “notebooks”, and more particularly office computers, constitute terminals having more limited capabilities.

At present, in the light of the above observations, the reception, by a local terminal, of electronic messages arising from the most diverse remote terminals, is manifested as an all or nothing reception by the local terminal, possibly accompanied by a lack of integrity of certain messages received, at least as regards the replaying of these messages.

Specifically, the current processes for managing the electronic messaging of terminals do not in any way allow the user of a local terminal to manage his availability in relation to certain of his counterparts, users of remote terminals.

Furthermore, the user of any local terminal, when dispatching electronic messages or files to remote terminals, may not take account of the specifics of the remote terminal of some of his counterparts, in particular as regards hardware and/or software compatibility in relation to the nature and the content of the electronic messages transmitted.

The object of the present invention is to remedy the drawbacks of the methods and systems for managing electronic messages of the prior art, email messages for access and/or response to networked sites, such as HTML pages and their accompanying files, by the instigation of supervision of the accessibility of any local terminal in relation to remote terminals, each remote terminal possibly playing the role of a local terminal and vice versa.

Another object of the present invention is, consequently, the implementation of a method and a system allowing any user of a terminal, referred to as the local terminal, to declare himself easily and temporarily or definitively available, and therefore accessible, or unavailable and therefore inaccessible, in relation to all or some of his counterpart users of remote terminals.

Another object of the present invention is also the implementation of a method and a system allowing any user of a terminal, referred to as the local terminal, to notify his availability, and therefore his accessibility, temporary or definitive, to all or some of his counterpart users of remote terminals.

Another object of the present invention is finally the implementation of a method and a system allowing any user of a terminal, local terminal or remote terminal, to take into account, in a substantially automatic manner, the hardware and/or software compatibility of any remote terminal, respectively local terminal, and thus to confer upon any transaction by dispatch of electronic message between these terminals optimal accessibility from terminal to terminal.

The method of managing the accessibility of the electronic address of a local terminal of a user by one or more remote terminals each furnished with an electronic address, the subject of the present invention is noteworthy in that it consists in compiling the set of electronic addresses of each remote terminal into at least one list of electronic addresses of counterparts of this user, in subdividing the set of electronic addresses into distinct groups of electronic addresses, in allocating each distinct group of electronic addresses a specific privileged accessibility function chosen from among a plurality of privileged accessibility functions, each privileged accessibility function exhibiting a different degree of accessibility from the degree of accessibility of the other accessibility functions of this plurality of privileged accessibility functions, so as to compile groups of electronic addresses of distinct privileged accessibility.

The system for managing the accessibility of the electronic address of the local terminal of a user by one or more remote terminals each furnished with an electronic address, the subject of the invention, is noteworthy in that it comprises a specific interactive server networked with these terminals. The interactive server comprises at least a front-end access module allowing interactive logon of any local terminal, a reconfigurable allocation, to at least one group of electronic addresses of several remote terminals, of a privileged accessibility function and to compile at least one group of electronic addresses of several remote terminals of privileged accessibility to the electronic address of this local terminal. A module for notification is provided in order to notify, on the one hand, any remote terminal whose electronic address belongs to the set of electronic addresses constituting a list of electronic addresses of counterparts of this user and of the local terminal of the latter, and, on the other hand, any remote terminal of a potential counterpart, of messages for notification and for updating of the current accessibility of the electronic address of said local terminal by each remote terminal.

The invention furthermore covers a terminal, local or remote, furnished with an electronic access address, this terminal being connected to an electronic network to which remote terminals each furnished with an electronic address are connected, this terminal comprising at least, stored in specific memory a set of electronic addresses of each remote terminal compiled into at least one list of electronic addresses of counterparts of the user of this terminal, a plurality of distinct groups of electronic addresses, these distinct groups being compiled from this list of electronic addresses of counterparts of this user of the terminal, at least one specific privileged accessibility function chosen from among a plurality of privileged accessibility functions, each privileged accessibility function exhibiting a different degree of accessibility from the degree of accessibility of this plurality of privileged accessibility functions, so as to compile groups of electronic addresses of distinct privileged accessibility to the electronic access address of this terminal.

The method and the system which are the subjects of the invention find application in the management of the accessibility of the electronic address of terminals of any type.

In particular, the concept of electronic address covers not only any combination of alphanumeric characters liable to constitute the electronic address for networked access, IP address, of any terminal, but also any combination of digits liable to constitute the telephone call electronic address of any mobile radiotelephony terminal, furthermore furnished or otherwise with an IP address.

The method, the system and the terminal allowing their implementation, in accordance with the subject of the invention, will be better understood on reading the description and on looking at the drawings hereinafter in which:

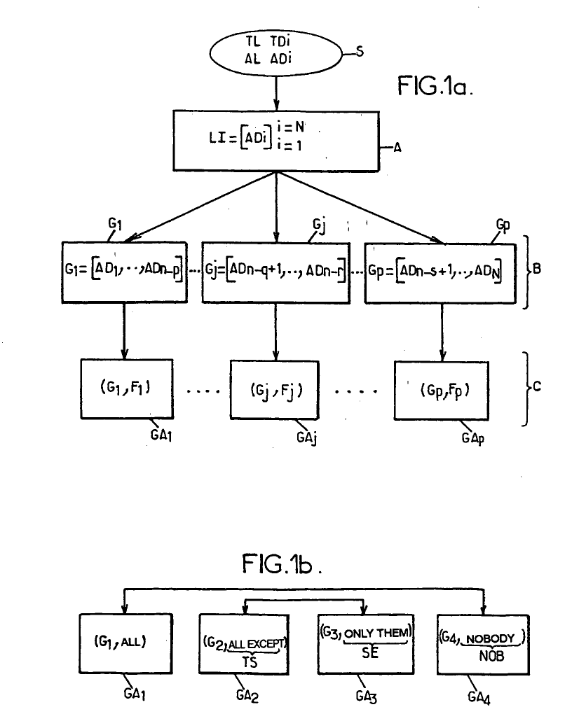

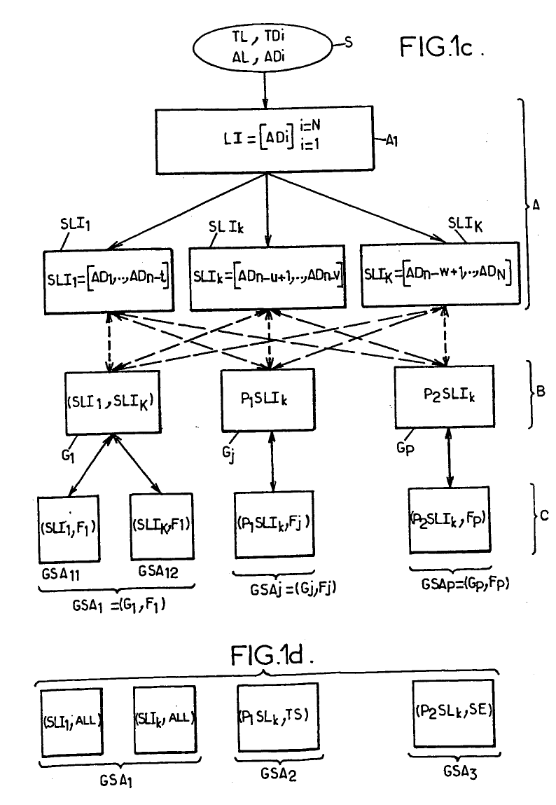

FIG. 1a represents, by way of illustration, a general flowchart for the implementation of the method of managing the accessibility of the electronic address of a local terminal by one or more remote terminals in accordance with the subject of the present invention;

FIG. 1b represents, by way of illustration, a variant implementation of an execution step of the method which is the subject of the invention as illustrated in FIG. 1a;

FIG. 1c represents, by way of illustration, a general flowchart for the implementation of a variant implementation of the method which is the subject of the invention as represented in FIG. 1a, this variant implementation exhibiting greater flexibility of use for the user of a local terminal;

FIG. 1d represents, by way of illustration, a detail of the implementation of an execution step of the method which is the subject of the invention as represented in FIG. 1c;

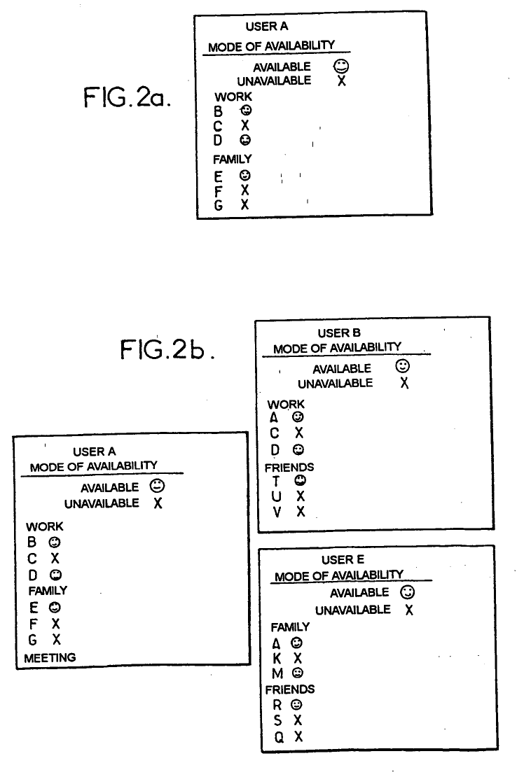

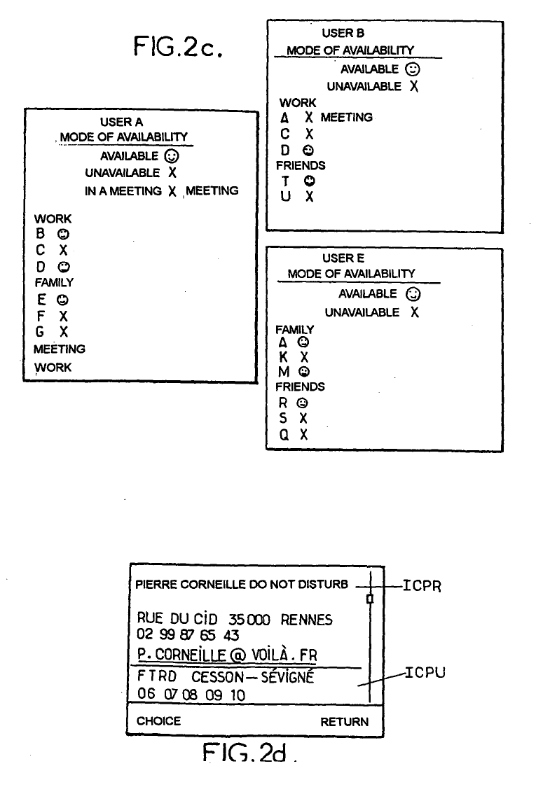

FIGS. 2a to 2c represent, by way of illustration, a preferred embodiment of the method which is the subject of the invention in which the groups and subsets of electronic addresses to which a privileged accessibility function is allocated are compiled in an environment very familiar to the user, in the form of directories or subdirectories also referred to as folders or subfolders;

FIG. 2d represents, by way of illustration, a mode of implementation of attributes relating to the user in the form of public respectively private electronic identity cards;

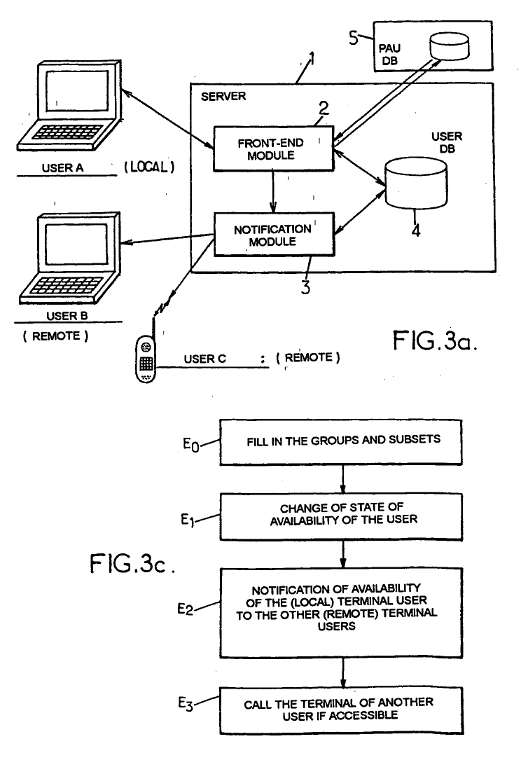

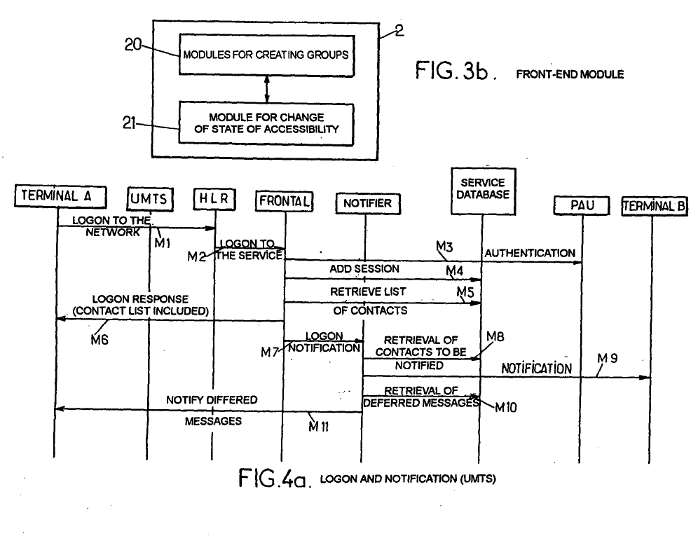

FIG. 3a represents, purely by way of illustration, the architecture of a system for managing the accessibility of the electronic address of a local terminal by a plurality of remote terminals in accordance with the subject of the present invention;

FIG. 3b represents, by way of illustration, a detail of the implementation of a constituent front-end access module of a management system as represented in FIG. 3a:

FIG. 3c represents, by way of illustration, a flowchart of the essential operations carried out by the system which is the subject of the present invention represented in FIGS. 3a and 3b;

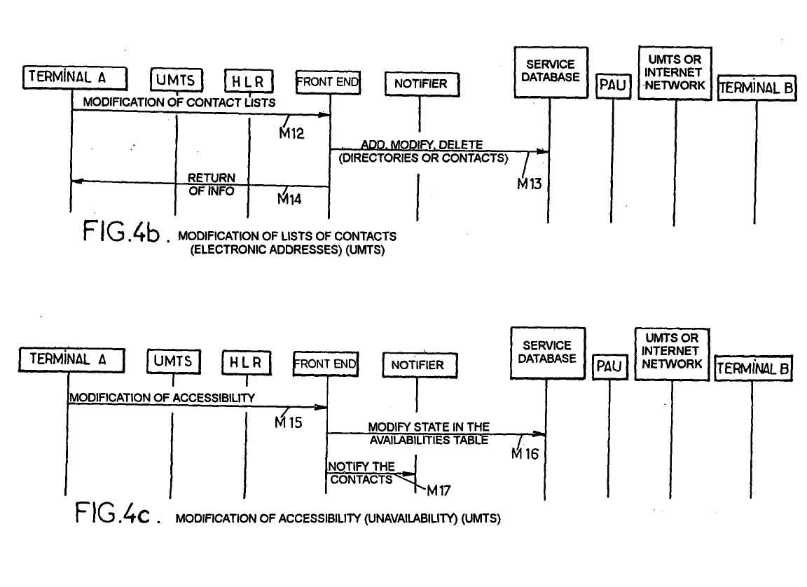

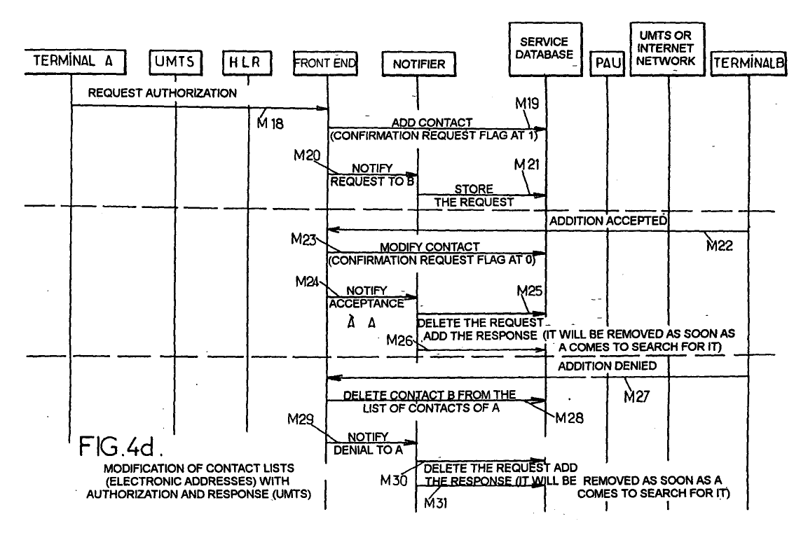

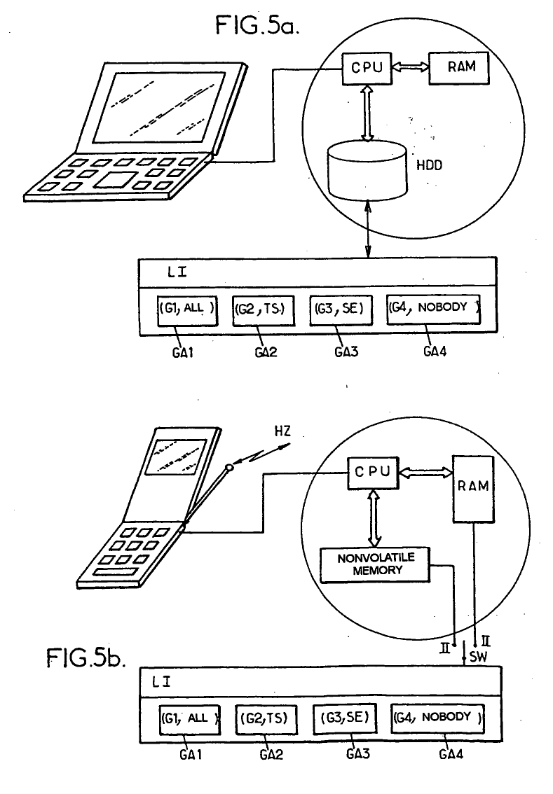

FIG. 4a represents, by way of illustration, a protocol for exchanging messages between a local terminal and a remote terminal by way of a system which is the subject of the present invention, when the local terminal constituted by a mobile radiotelephony terminal is for example interconnected by way of a UMTS network, during a logon and notification operation;

FIG. 4b represents, by way of illustration, a protocol for exchanging messages between a local terminal and a remote terminal by way of a system which is the subject of the present invention, when the local terminal constituted by a mobile radiotelephony terminal is for example interconnected by way of a UMTS network, during an operation for modifying the list of electronic addresses constituting the list of counterparts for the local terminal;

FIG. 4c represents, by way of illustration, a protocol for exchanging messages between a local terminal and remote terminal by way of a system which is the subject of the present invention, when the local terminal constituted by a mobile radiotelephony terminal is for example interconnected by way of a UMTS network, during an operation for modifying the privileged accessibility to the local terminal;

FIG. 4d represents, by way of illustration, a protocol for exchanging messages between a local terminal and a remote terminal by way of a system which is the subject of the present invention, when the local terminal constituted by a mobile radiotelephony terminal is for example interconnected by way of a UMTS network, during an operation for appending an electronic address to the list of counterparts which is submitted for authorization of the relevant counterpart;

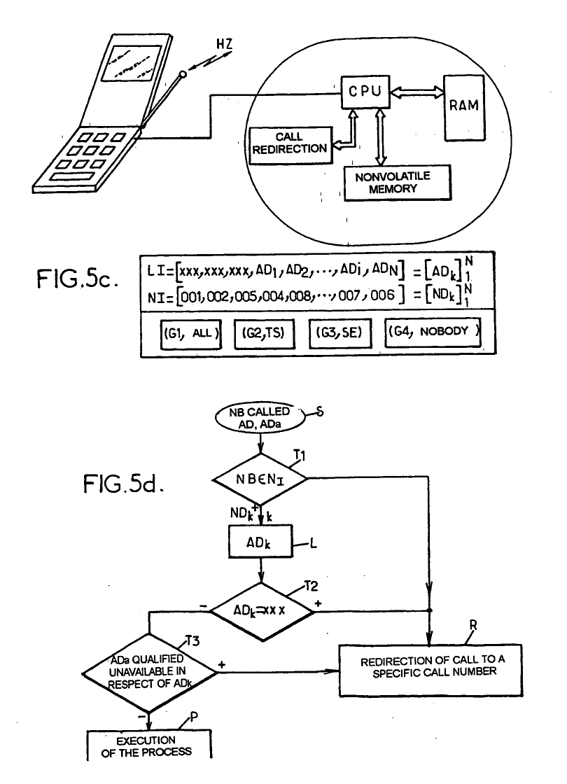

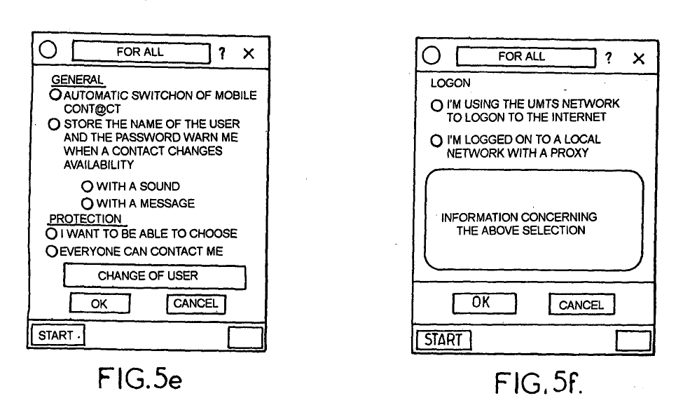

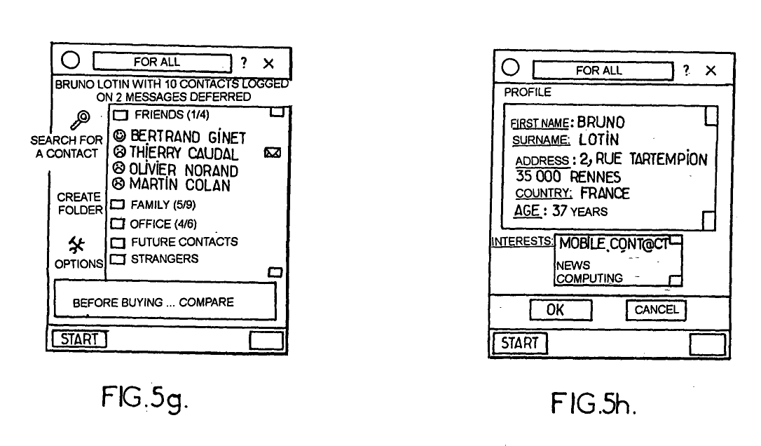

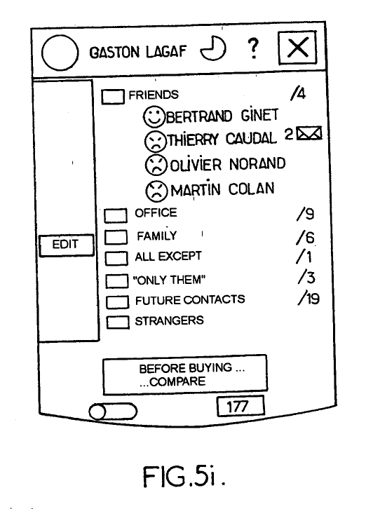

FIG. 5a represents, by way of illustration, a terminal of office computer or portable computer type, connected to an IP network and allowing the implementation of the method and of the system which are the subjects of the present invention;

FIG. 5b represents, by way of illustration, a terminal of mobile radiotelephony terminal type, connected to a UMTS or GPRS network, and allowing the implementation of the method and of the system which are the subjects of the present invention;

FIG. 5c represents, by way of illustration, a terminal of mobile radiotelephony terminal type, connected for example to the GPRS or UMTS network, and making it possible to provide, by virtue of the method which is the subject of the invention, for the management of the electronic address and of the telephone call number of a remote terminal furnished or not furnished with an electronic address;

FIG. 5d represents, by way of illustration, a flowchart for the joint management of the telephone call number and of the electronic address of a remote terminal constituted by a mobile radiotelephohy terminal as represented in FIG. 5c;

FIGS. 5e to 5i represent various screen pages displayed at the level of a terminal, local or remote terminal, so as to allow the execution of the method which is the subject of the invention by any inexperienced user from a graphical interface.

A more detailed description of the method for managing the accessibility of the electronic address of a local terminal of a user by one or more remote terminals, each furnished with an electronic address, will now be given in conjunction with FIGS. 1a to 1d and 2a to 2c.

As mentioned previously in the description, a terminal is said to be local as opposed to any terminal said to be remote when this remote terminal is the terminal of a user who is the counterpart of the user of the aforesaid local terminal. Furthermore, it is indicated that, within the framework of the description of the present patent application, and in particular of the management method and system which are the subjects of the invention, the terminal is said to be local when the method which is the subject of the present invention is implemented from this terminal, as will be described hereinbelow.

Consequently, with reference to FIG. 1a, there is considered the successive steps or states allowing the implementation of the method for managing the accessibility of the electronic address of a local terminal TL furnished with an electronic address, IP address designated AL, and of a plurality of remote terminals, denoted TDi, each furnished with an electronic address ADi in the starting step S.

In the light of the aforesaid starting step, the method which is the subject of the present invention consists, in a step A, in compiling the set of electronic addresses of each remote terminal into at least one list, denoted LI, of electronic addresses of counterparts of the user of the local terminal TL.

The aforesaid list is denoted:

LI=[ADi]ₗ^{N}

where ADi designates the electronic address of each remote terminal TDi. N designates the number of remote terminals whose users constitute the counterparts of the user of the local terminal TL.

The concept of list is understood in fact to mean any arrangement of the electronic addresses ADi of the remote terminals TDi in the form of compiled lists evidencing a list processing in accordance with the concept of list according to the definition of high-level programming languages, or in the form of files for which a read-processing makes it possible to discriminate any address ADi of rank i among the set of N addresses constituting this file.

The step A is then followed by a step B consisting in subdividing the set of aforesaid electronic addresses into distinct groups of electronic addresses. In FIG. 1a, the groups are denoted G₁, . . . , Gⱼ, . . . , Gₚ where P designates the number of groups arising from the subdivision operation.

As far as the aforesaid subdivision operation is concerned, it is indicated that the latter is left to the sole initiative of the user of the local terminal TL, as will be described in greater detail subsequently in the description.

For this reason, the group G₁ is assumed to contain the electronic addresses AD₁, . . . , ADₙ₋ₚ, the group of rank j, Gⱼ, is deemed to comprise the addresses AD_{n-q+1}, . . . , ADₙ₋ᵣ and the group Gₚ is deemed to comprise the addresses ADₙ₋ₛ₊₁, . . . , ADₙ.

In the above notation, it is indicated that n, p, q, r and s have any values whatsoever, since the aforesaid subdivision operation is left to the sole initiative of the user of the local terminal TL.

Step B is then itself followed by a step C consisting in allocating a specific privileged accessibility function, chosen from among a plurality of functions of privileged accessibility, to each distinct group of electronic addresses. In FIG. 1a, the privileged accessibility functions are denoted F₁, . . . , Fⱼ, . . . , Fₚ.

In a general manner, it is indicated that each privileged accessibility function exhibits a different degree of accessibility than the degree of accessibility of the other privileged accessibility functions. Under these conditions, the association, in step C, of a privileged accessibility function with each group, the association operation being denoted (Gⱼ, Fⱼ), makes it possible to compile distinct groups of electronic addresses of privileged accessibility, these groups (G₁, F₁), . . . , (Gⱼ, Fⱼ), . . . , (Gₚ, Fₚ) being denoted GA₁, GAⱼ, GAₚ respectively.

In a general manner, it is indicated that the accessibility functions F₁, Fⱼ to Fₚ and, consequently, the corresponding groups of electronic addresses of privileged accessibility GA₁, GAⱼ to GAₚ may correspond to diverse logic functions allowing the user of the local terminal TL to in fact allocate to all or some of his counterparts a determined accessibility level, as a function in particular of the degree of availability enjoyed by the user of the local terminal TL in relation to them.

Various modes of implementation of the aforesaid accessibility functions Fⱼ will now be described in conjunction with FIG. 1b.

Described, in a nonlimiting manner, in FIG. 1b are four distinct groups of electronic addresses of privileged accessibility GA₁, GA₂, GA₃ and GA₄.

Thus, the group GA₁ corresponds to a group designated ALL, ALL in fact designating the accessibility function F₁ allocated to the group G₁, for which group, restrictionless unreserved accessibility to the local electronic address AL is allocated, by way of the accessibility function F₁, to all the electronic addresses belonging to the group G₁.

Likewise, the group GA₂ corresponds to a group designated ALL EXCEPT, where ALL EXCEPT, designated AE for short, corresponds to a privileged accessibility function F₂, for which group, restrictionless unreserved accessibility to the local electronic address AL is allocated, by way of the accessibility function F₂, AE, to all the electronic addresses not belonging to this group.

The group GA₃ corresponds to a group whose accessibility function is a function ONLY THEM, designated SE for short, associated with the group G₃, the distinct privileged accessibility group GA₃ being such that, restrictionless unreserved accessibility to the local electronic address AL is allocated, by way of the accessibility function ONLY THEM, SE, to all the electronic addresses belonging to this group.

The group GA₄ whose accessibility function is designated NOBODY, or NOB for short, for which no accessibility to the local electronic address AL is allocated, by way of the accessibility function F₄, that is to say the function NOBODY NOB, to all the electronic addresses of the group G₄ belonging to this group.

It is thus understood that as a function of the allocation of the distinct accessibility functions ALL, ALL EXCEPT AE, ONLY THEM SE, or NOBODY NOB, to the various groups of electronic addresses G₁, Gⱼ to Gₚ by the user of the local terminal, the latter can thus modulate the accessibility to his local terminal TL as a function of his degree of availability for one or more of the remote terminals of electronic address ADi belonging to the relevant group. This modulation is of course a modulation of the accessibility as a function of the electronic addresses of each remote terminal and, naturally, as a function of the person of the user of each of these remote terminals, whereas in the example given in FIGS. 1a and 1b, one limits oneself for the moment to accessibility, that is to say to availability of the user of the local terminal TL corresponding to strict accessibility or to inaccessibility for a degree of availability having two levels, available or unavailable.

It is indicated of course that the designation of the aforesaid logic functions ALL, ALL EXCEPT, AE, ONLY THEM, SE, and NOBODY, NOB, can be displayed plainly for the attention of the user of the local terminal TL, although such functions may be implemented on the basis of list processing predicates for example.

By way of nonlimiting example, for the implementation of the accessibility function ALL EXCEPT, AE, the corresponding accessibility function F₂ may be obtained, for example, by disjunction of the list LI, comprising the set of electronic addresses of the remote terminals ADi, and of the set of electronic addresses of the group of electronic addresses G₂ so as to compile a resulting list of electronic addresses in which the electronic addresses within the group G₂ have been excluded, and to which restrictionless unreserved accessibility to the local electronic address is allocated, whereas no accessibility to the aforesaid local electronic address AL is conferred upon the electronic addresses of the group of electronic addresses G₂.

The same holds as regards the accessibility functions ALL, ONLY THEM, SE, and NOBODY, NOB, for which operations on the aforesaid lists may be carried out in a conventional manner.

A preferred mode of implementation of the method which is the subject of the present invention as represented in FIGS. 1a and 1b, will now be described in conjunction with FIGS. 1c and 1d, which mode of implementation makes it possible to obtain greater flexibility of use for the user of the local terminal TL.

In accordance with the mode of implementation of FIG. 1c, it is indicated that the method which is the subject of the invention consists furthermore in compiling the set of electronic addresses of each remote terminal into subsets of distinct interest to the user.

Preferably, as represented in FIG. 1c, this operation is carried out by the user of the local terminal TL on completion of the compiling of the list LI of his counterparts.

For this reason, as represented in FIG. 1c, step A of FIG. 1a can advantageously be subdivided into two substeps, a substep A₁ corresponding to the compiling of the list of counterparts LI in accordance with step A of FIG. 1a, and a substep A₂ in which the list LI is in its turn subdivided by the user of the local terminal TL into constituent sublists of each subset of distinct interest to the latter.

In FIG. 1c, the sublists are denoted:

SLI₁, . . . , SLIₖ, . . . , SLIₖ with:

SLI₁=[AD₁, . . . , ADₙ₋ₜ]

SLIₖ=[ADₙ₋ᵤ₊₁, . . . , ADₙ₋ᵥ]

SLIₖ=[AD_{n-w+1}, . . . , ADₙ]

In the above notation, n, t, u, v and w have any values whatsoever, since the operation of compiling the subsets of distinct interest, by partitioning the list LI, is left to the sole initiative of the user of the local terminal TL.

It is understood in particular that each subset of distinct interest to the user can correspond to subsets of interest which are such that counterparts belonging to the family, friends, colleagues or workmates of the user of the local terminal TL for example, as will be described in greater detail subsequently in the description.

Step A is then itself followed by step B of FIG. 1a on the initiative of the user of the local terminal TL, who may then proceed to the grouping of certain subsets of distinct interest with a view to the allocating of a common specific privileged accessibility function to the latter.

It is of course understood that substep A₂ and step B may, as appropriate, be swapped without departing from the scope of the subject of the present invention.

It is also understood that the user of the local terminal TL has complete latitude in performing any combination between the partitioning into subsets of distinct interest and the compiling of the groups of electronic addresses Gⱼ. For this reason, the link between the various blocks of substep A₂ and of step B is represented by multiple double arrows from block to block, represented dashed.

In particular and for this reason, in FIG. 1c, is represented the association of the subsets SLI₁ and SLIₖ obtained in substep A₂, so as to compile the group of electronic addresses G₁, the partitioning of the subset of distinct interest SLIₖ into elementary subsets P_{1SLIk} and P_{2SLIk} respectively, the first elementary subset P_{1SLIk} being intended to form the group of electronic addresses Gⱼ, and the second elementary subset P_{2SLIk} being intended to form the group of electronic addresses Gₚ as represented in FIG. 1c.

The operation of allocating to each distinct group of electronic addresses thus compiled of a privileged accessibility function in step C is then carried out and corresponds, by way of nonlimiting example in FIG. 1c, to the allocating of one and the same accessibility function F₁ to the subsets SLI₁ and SLIₖ of the group of electronic addresses G₁ so as to compile a group of electronic addresses of distinct privileged accessibility GSA₁ formed of two subgroups GSA₁₁ and GSA₁₂.

The same holds for the group of electronic addresses Gⱼ formed by the elementary subset P_{1SLIk} to which the privileged accessibility function Fⱼ is allocated, and, for the elementary subset P_{2SLIk} to which the privileged accessibility function Fₚ is allocated.

By way of nonlimiting example, as represented in FIG. 1d, the function F₁ implemented in step C of FIG. 1c can correspond to the function ALL, the privileged accessibility function Fⱼ can correspond to the function ALL EXCEPT, AE, and the privileged accessibility function Fₚ to the function ONLY THEM, SE, for example.

It is thus understood that the user of the local terminal TL has complete latitude in organizing the accessibility to his local terminal TL as a function, on the one hand, of his actual availability and, on the other hand, of relational criteria in relation to his counterparts in the light of their personal and/or professional qualities.

In a general manner, it is indicated that, in a preferred mode of implementation, the specific functions of privileged accessibility and, of course, the distinct groups of electronic addresses of privileged accessibility, are complemented pairwise, with a view to facilitating the management of the accessibility level conferred on the set of counterparts of the user of the local terminal TL.

Thus, with reference to FIG. 1b, it is indicated that the function F₁, ALL, and the privileged accessibility group GA₁, correspond to the complement of the accessibility function F₄, NOBODY, NOB, and to the complement of the group GA₄, whereas the privileged accessibility function ALL EXCEPT, AE, and the distinct group of electronic addresses of privileged accessibility GA₂ correspond to the complement of the privileged accessibility function F₃ ONLY THEM, SE, and to the complement of the distinct group of electronic addresses of privileged accessibility GA₃. The concept of complement is of course that of logical complement.

Naturally, the method which is the subject of the present invention is implemented, in a preferred manner, in software manner, so as to facilitate the use of any inexperienced user of a local terminal TL.

With this aim, a directory, or as appropriate a subdirectory, is advantageously associated with each list or sublist of electronic addresses, such as the lists and sublists arising from the operations for defining the groups in step B, respectively the subsets in substep A₂, with the exception of course of the compiling of the list of counterparts LI in substep A₁ or A of FIG. 1a. Thus, preferably, with each subset of distinct interest, consisting for example of a sublist SLIₖ, may be associated a directory and, with each distinct group of electronic addresses, may be associated a subdirectory, as described in step B in conjunction with FIG. 1c.

Naturally, a specific privileged accessibility function is associated with each subdirectory.

In this way, to each remote terminal electronic address registered in the directory, respectively the relevant subdirectory, is allocated the specific privileged accessibility associated with this subdirectory solely because this remote terminal electronic address belongs to the aforesaid directory and to the aforesaid subdirectory.

It is understood in particular that the concept of directory and of subdirectory is standard for any normally competent user, the concept of aforesaid directory and aforesaid subdirectory corresponding also to the concept of folder, respectively of subfolder, of all the graphical interfaces associated with the operating systems currently available on the market, and in particular of the more usual ones.

It is thus understood that, by virtue of the use of the aforesaid graphical interfaces, the user of the local terminal TL is able, through a simple drag and drop operation by means of a pointing device, such as a mouse or the like, to allocate a privileged accessibility function corresponding to that of a subdirectory, as the case may be a directory, chosen by the latter, to any group of electronic addresses of remote terminals.

Naturally, and by virtue of the adopted configuration of the groups and subsets of electronic addresses in the form of subdirectories, respectively of directories, it is convenient to allocate them names evocative of the privileged accessibility function conferred upon them. Under these conditions, the accessibility to the local terminal TL by the remote terminals TDi may then be managed in the simplest manner by the user of the relevant local terminal.

It is indicated in particular that the deletion of a subdirectory amounts ultimately to deleting the privileged accessibility function associated therewith, this allowing the user of the local terminal TL to ensure particularly simple execution of the implementation of the method which is the subject of the present invention.

The method may then be executed on the basis of a computer program installed on the local terminal TL when the latter consists for example of an office microcomputer or of a portable microcomputer, that is to say one endowed with sufficient processing and storage capabilities, or, conversely, installed on a server when the terminal is a mobile radiotelephony terminal for example, as will be described subsequently in the description. The aforesaid computer program makes it possible to append specific directories and of course modes of privileged accessibility related to them. It must of course make it possible to carry out any notification of the level of accessibility to the local terminal TL conferred by the user of the latter on the remote terminals TDi whose users are the counterparts.

A more specific description of organizing directories within the framework of the implementation of the method which is the subject of the invention will now be given in conjunction with FIGS. 2a to 2c.

Represented in FIG. 2a are the directories created by a user A of a local terminal in relation to users B, C, D, E, F, G of remote terminals, the user A having created subsets in substep A₂, these subsets being compiled into directories, such as Work, Family, the user A having defined two modes of availability:

available, represented by a smiling face icon or logo;

unavailable, represented by a cross X.

The configuration represented in FIG. 2a can for example be obtained by compiling a group of electronic addresses of privileged accessibility, such as the group GA₃ of FIG. 1b corresponding to the function ONLY THEM, SE, for the users B, D and E of the subsets of distinct interest consisting of the directories Work and Family.

In the case of FIGS. 2b and 2c, represented in FIG. 2b is the user A, who has moreover called upon a mode of so-called qualified availability, in which an additional item of information, relating either to the reason for his unavailability, or to the relative duration of this unavailability, may be introduced.

With this aim, the user A has created a specific directory, denoted Meeting, corresponding for example to one of the subsets created in substep A₂ of FIG. 1c. The mode of availability related to this specific directory is designated “I'm in a meeting”, this mode of availability thus corresponding to a mode of qualified availability.

The copying of the Work directory into the Meeting directory, as represented in FIG. 2c, has the consequence that all the users of remote terminals contained in the Meeting directory, that is to say in the example given in FIGS. 2b and 2c, the users B, C and D, thus see the user A as unavailable. The qualified unavailability thus obtained results from the association of the Unavailable mode of availability with the Meeting directory and of the adding of the meeting item of information to the directory, and hence to the group of electronic addresses of corresponding privileged accessibility thus compiled.

The users not belonging to the Meeting directory, such as the user E belonging to the Family directory, see the user A on the other hand as available. The availability and unavailability characters are of course represented by the smiling face icon, respectively the cross X mentioned above in respect of the users B, respectively E in FIG. 2c.

Of course, any modification of the level of accessibility of the user A, the user of the local terminal TL, in relation to one or more of the remote terminals, is notified to them by way of a networked connection and a server, as will be described subsequently in the description.

In order to ensure optimal accessibility between remote terminal and local terminal, or vice versa, in accordance with the method which is the subject of the invention, a set of specific attributes which is representative of this distant or local terminal and of its user is then associated with each electronic address of this distant or local terminal.

Specifically, in order to ensure the aforesaid optimal implementation, it is appropriate to allow the replaying at the level of each terminal, local or remote, of the essential information relating to the accessibility and of course to the availability of the remote terminal, respectively local terminal. It is in fact recalled that each local terminal can constitute a remote terminal in relation to a remote terminal playing the role of a local terminal, whose user implements the method which is the subject of the present invention.

In a general manner, it is indicated that the specific attributes representative of the remote or local terminal and of the user of the latter are constituted by a file related to the electronic address of the local or remote terminal. This file can be stored at the level of a specific memory of the relevant terminal, or as the case may be of the terminal and of the server allowing the implementation of the method which is the subject of the present invention.

As represented in FIG. 2d, the specific attributes representative of the user of a terminal comprise at least one public electronic identity card, denoted ICPU, accessible from all the electronic addresses of a remote terminal. This public electronic identity card can comprise the professional address of the user of the relevant terminal, the telephone call number of the latter and all the information relating to the latter's professional life.

Furthermore, the aforesaid specific attributes can comprise a private electronic identity card, denoted ICPR, accessible from only those electronic addresses of a remote terminal belonging to at least one subset of distinct interest to the user. The private electronic identity card can comprise the personal address of the user, his personal telephone number, the electronic address of a terminal available at the residence of the latter. Of course, other information may be mentioned, either in the public electronic identity card, or in the private electronic identity card.

As far as the specific attributes representative of a terminal are concerned, they may comprise, at least, a terminal class attribute, chosen from among a group of classes of terminal and of their operating system, classes of terminal such as microcomputer, digital assistant, mobile radiotelephony terminal equipped with a display screen. The aforesaid specific attributes may also comprise a communication service level attribute comprising for each class of terminal parameters of display and/or of navigation interfacing for example.

Specifically, access to the services for implementing the method which is the subject of the invention may depend on the type of terminal employed by the user.

By way of nonlimiting example, it is indicated that the downloaded applications are generally of a different nature, streamlined version, depending on the nature of the terminal used. This involves recognition of the terminal during the implementation of the method which is the subject of the present invention. Of course, this recognition is carried out as a function of the associated attributes corresponding to the electronic address of the aforesaid terminal.

In a general manner, three classes of terminals may be distinguished:

microcomputer terminal, with screen, keyboard and operating system of Windows, Linux or other type, whether the microcomputer be of office computer or portable computer type;

mobile terminal with screen, such as digital assistant, with or without keypad and touch screen and furnished with a streamlined operating system such as Windows CE, Palm OS, these mobile terminals being of the PDA or Handheld PC type;

mobile radiotelephony terminal with small display screen whose dimensions are of the order of 40×30 mm, digital keypad and compatible with graphical interfacing software of WAP type, standing for Wireless Application Protocol and/or of SAT type, standing for SIM Application Toolkit. This type of terminal corresponds to a SMARTPHONE type terminal.

As far as the service levels allotted to each of these types of terminal are concerned, the service levels must be envisaged as a function of the terminal used.

Thus, the three classes of aforesaid terminals define three service levels for which it is appropriate to adapt functionalities in terms of possibilities and contents, according to the table T introduced below:

| | | | |
|---|---|---|---|
| Characteristics | Smartphone | Palm PC | PC |

Screen

| | | | |
|---|---|---|---|
| Size of the | 4 × 4 | 8 × 6 | 21 × 11 |
| display in cm | | | |
| Resolution | 180 × 180 | 260 × 195 | 21 × 11 |
| Touch sensitive | N | Y | N |
| Colors | 256 | 65 K colors | 16 millions |

Navigation

| | | | |
|---|---|---|---|
| Buttons | Y | N | Y(TAB, |
| | | | arrows, etc.) |
| Stylus | N | Y | N |
| Mouse | N | N | Y |
| Multiwindow | N | Overlayed | Y |

It is thus understood that as a function of the specific attributes representative of a terminal, such as a remote terminal, it is thus possible to customize and therefore to optimize the information communicated to this terminal as a function of the type of terminal employed by the counterpart.

A system for managing the accessibility of the electronic address of the local terminal of a user by one or more remote terminals, in accordance with the method which is the subject of the present invention, will now be described in conjunction with FIGS. 3a to 3c then 4a to 4d.

More specifically, with reference to FIG. 3a, it is indicated that the system which is the subject of the present invention comprises an interactive server, denoted 1, specific server networked with the terminals capable of implementing the method which is the subject of the present invention. By way of nonlimiting example, a local terminal has been represented, consisting of an office microcomputer, assigned to a user A, a first remote terminal, consisting of a portable computer assigned to a user B, and a second remote terminal, consisting of a mobile radiotelephony terminal, assigned to a user C.

Of course, the method and the system which are the subject of the present invention are independent of the mode of linking of each terminal, local respectively remote, to the server 1. Thus, whereas any office or portable microcomputer can be interconnected to the server 1 by way of the IP network, the connecting of any terminal consisting of a mobile radiotelephony terminal is carried out by way of a radio telephony link such as for example a UMTS link or a GPRS link for example.

As represented in FIG. 3a, the interactive server 1 comprises at least one front-end access module 1, allowing interactive connecting of any local terminal, so as to ensure, on the initiative of the user of this local terminal, that is to say the user A in FIG. 3a, a reconfigurable allocation to at least one group of electronic addresses of several remote terminals, such as the terminals for the users B and C in FIG. 3a, of a privileged accessibility function and to compile at least one group of electronic addresses of privileged accessibility to the electronic address of the local terminal of the user A. It is of course understood that the aforesaid dynamic allocation corresponds in fact to the implementation of the method which is the subject of the present invention as described previously in conjunction with FIGS. 1a to 1d, then 2a to 2d and to table T.

The specific interactive server 1 also comprises a module 2 for notifying any remote terminal, terminal of the users B and C in FIG. 3a, whose electronic address belongs to the set of electronic addresses constituting a list of electronic addresses of counterparts of this user and of the local terminal of the latter, list LI previously described in the description, of messages of notification and of updating of the current accessibility of the electronic address of the local terminal of the user A by each remote terminal, the terminals of the users B and C in FIG. 3a. The notification of the messages of notification and of updating of the current accessibility of the electronic address of this local terminal is also performed to any remote terminal of a potential counterpart defined by this user on his local terminal.

By way of nonlimiting example, it is indicated that the specific interactive server 1 is of course furnished with a user database, bearing the reference 3, for which the storing of the information relating to the allotting of privileged accessibility functions is carried out by way of the front-end module 2, and to ensure the notification of the updating messages to the remote terminals by way of the notification module 3, from the reading of the aforesaid updates on the user database.

Finally, and in a nonlimiting manner, a user database, the so-called PAU standing for Unique Authentication Point, may be associated with the server 1, this database, bearing the reference 5, providing for the management of the subscribers of the users entitled to implement the method which is the subject of the present invention from their terminal playing the role of local terminal and from any remote terminal likewise entitled to implement the method which is the subject of the present invention.

By way of nonlimiting example, it is indicated moreover that the database with single authentication points, bearing the reference 5, may be incorporated directly into the server 1 and, for example, consist of an auxiliary database in relation to the user database.

When the relevant terminal, such as an office microcomputer or a portable microcomputer, exhibits sufficient processing and storage capabilities, the method which is the subject of the present invention can be implemented on the basis of software modules loaded in part onto the hard disk of these terminals, these software modules corresponding for example to modules for creating directories, for modifying directories and of course for associating privileged accessibility functions with them, as described previously in the description. Under these conditions, the aforesaid software modules may furthermore comprise any software module for synchronizing files making it possible in particular, when modifying a directory and or associated accessibility function, by comparison with the corresponding earlier configuration, to transmit to the front-end module and ultimately to the user database, only the modifications actually introduced by the user of the local terminal, that is to say the user A.

Conversely, when the local terminal consists of a mobile radiotelephony terminal, and hence has much more limited processing capabilities, such as the terminal of the user C in FIG. 3a, the crux of the aforesaid software modules may advantageously be located at the level of the server 1, the creating, the modifying of the directories and the associating of the privileged accessibility functions with them possibly being carried out interactively between the aforesaid terminal, playing the role of local terminal, and the server 1.

In all cases, following the receipt by the front-end module 2 of any modifications performed from a local terminal of any type whatsoever, the aforesaid server 1 undertakes the storage of these modifications on behalf of the user of the relevant local terminal of the user database 4.

Following the aforesaid storage operation, the notification module 3 then makes possible, by reading the modifications made, to undertake the notification of these modifications to each relevant terminal, based of course on the electronic address of each of them.

The operations carried out by the system which is the subject of the present invention, in particular in the server 1, are represented in FIG. 3c in the following manner.

When creating or modifying directories and associating them with privileged accessibility functions at the level of a local terminal, a first operation consists of an operation denoted E₀, consisting in filling in the groups and subsets by dispatching a message to the front-end module 2 of the specific interactive server 1.

The aforesaid operation E₀ is followed by an operation E₁ consisting, at the level of the front-end module, in cataloguing all the changes of state of availability of the user of the local terminal, the user A in FIG. 3a. This operation makes it possible moreover to catalogue the set of remote terminals for which a modification has occurred. The set is then stored at the level of the user database 4.

The step E₁ is followed by a step E₂ of notification of availability of the user of the local terminal to the other users of a remote terminal, through a command of the notification module 3, this command carrying out in succession the reading of the modifications introduced on the user database and, of course, the reference and the electronic addresses of the remote terminals for which a modification has occurred. The notification module 3 then undertakes the notification proper of the pertinent modifications to each remote terminal, the terminals of the users B and C in FIG. 3a.

Step E₂ can then be followed by a E₃ of calling the terminal of another remote user to which the modification is relevant, if this new user is accessible, and in the case where any user subject to notification is not himself accessible.

As far as the front-end module 2 is concerned, or more specifically the server 1, the latter, in order to provide for the implementation of the method, which is the subject of the present invention, at the level of the terminals consisting of mobile radiotelephony terminals having low capabilities, can furthermore comprise, as represented in FIG. 3b, a module for creating groups, bearing the reference 20, these groups corresponding for example to directories or subdirectories with which an accessibility state change module 21 is associated. The module for creating groups consists in fact in allocating a directly or subdirectory to any list or sublist of addresses of remote electronic terminals ADi which is obtained by subdivision and/or partition, so as to compile lists and sublists, as mentioned previously in the description. The accessibility state change module 21 can consist in calculating the intersections of lists previously described so as to produce the accessibility functions described previously in the description in conjunction with the method which is the subject of the present invention.

Of course, when the terminal playing the role of local terminal is a terminal of microcomputer type, the aforesaid group creation module and accessibility state change module 20 and 21 may be installed at the level of the aforesaid terminal.

By way of nonlimiting example, a protocol for exchanging messages between a local terminal, such as that of the user A, and a remote terminal, such as that of the user B, will now be described in conjunction with FIGS. 4a to 4d in the case where the local terminal of the user A is a mobile radiotelephony terminal connected to the UMTS network.

As far as the connection of the remote terminal of the user B is concerned, this connection can be effected in any way, that is to say either by way of the UMTS network, or by way of the IP network, the INTERNET network. In either case, the remote terminal of the user B then consists of a mobile telephony terminal, respectively of an office microcomputer or a portable microcomputer.

FIG. 4a represents the various messages exchanged in respect of the logon and notification operations.

The messages exchanged are enumerated hereinbelow:

M₁: logon message for connecting the local terminal of the user A to the HLR unit, standing for Home Location Register, this message M₁ being transmitted by way of the UMTS network;

M₂: logon message for connecting the HLR unit to the front-end module 2;

M₃: message authenticating the front-end module 2 to the database PAU, 5 and, on successful authentication,

M₄: session add message;

M₅: retrieval of the list of contacts, that is to say of the list of addresses of the remote terminals of the counterparts of the local terminal of the user A;

M₆: logon response message including the list of contacts retrieved by the message M₅ from the front-end module to the local terminal of the user A.

It is noted in particular that this protocol makes it possible to restore the existing configuration to the local terminal, and, of course, during a first switch-on from the local terminal of the user A, an empty list for the included list of contacts.

The operation of notification, from the front-end module 2, comprises the following messages:

M₇: message of notification of logon from the front-end module 2 to the notification module 3;

M₈ retrieval of the contacts to be notified to the user database 4;

M₉: message of notification proper from the notification module 3 to the remote terminal of the user B.

Of course, the aforesaid protocol may be supplemented with deferred messages recovery messages, M₁₀, and deferred messages of notification, M₁₁, from the notification module 3 to the data and services base 4, respectively to the local terminal of the user A.

FIG. 4b relates to the exchanging of messages when modifying lists of contacts, that is to say electronic addresses of the counterparts of the user of the local terminal.

The messages implemented are as follows:

M₁₂: message of modification of the contact lists, addressed from the local terminal of the user A to the front-end module 2 by way of the UMTS network, that is to say of the lists and sublists described previously in the description in respect of the implementation of the protocol which is the subject of the invention, this message being addressed of course from the terminal of the user A to the front-end module 2 depending on the selection made by the user of the local terminal;

M₁₃: message of addition, modification or deletion of directories or electronic addresses in these directories, and addressed from the front-end unit 2 to the user database 4;

M₁₄: return message from the front-end module 2 to the local terminal of the user A, this message in fact constituting an acknowledgement of receipt.

FIG. 4c represents the message exchange protocol for the modification of the accessibility, that is to say of the availability declared by the user A of the local terminal in relation to one or more remote terminals.

The messages implemented are as follows:

M₁₅: message of modification of the state of availability depending on the user's choice;

M₁₆: message of modification of the state of availability in the availabilities table, the object of this message M₁₆ being, in the user database 4, to associate with any list or sublist as described previously in the description, a function of privileged accessibility from the set of functions of privileged accessibility at one's disposal. The message M₁₆ thus makes it possible to store, at the level of the user database 4, the set of modifications introduced;

M₁₇: post-modification contacts notification command message addressed by the front-end module 2 to the notification module 3.

The notification protocol can then be implemented following the reception by the notification module 3, according to the notification protocol described in conjunction with FIG. 4a.

FIG. 4d concerns the protocol for modifying the lists of contacts, that is to say the lists of electronic addresses with a given authorization and given response procedure by the remote terminal of the user B.

Under this assumption, the messages implemented are as follows:

M₁₈: authorization request message transmitted by the local terminal of the user A to the front-end module 2 by way of the UMTS network;

M₁₉: contact addition message comprising a request for confirmation by way of a flag with a determined value, such as the value 1 for example. The message M₁₉ is transmitted from the front-end module 2 to the user database 4;

M₂₀: message of notification of request for the attention of the remote terminal of the user B.

This message is addressed from the front-end module 2 to the notification module 3, the procedure for notification to the remote terminal of the user B being implementable thereafter in accordance with the notification protocol as described in conjunction with FIG. 4a;

M₂₁: message of storage of the request, addressed from the notification module 3 to the user database 4.

The authorization request procedure is terminated and is then subordinated to the response of acceptance or of denial on the part of the terminal B according to the protocols represented hereinbelow also in FIG. 4d.

On acceptance of the user B of the remote terminal, the addition requested by the local terminal being accepted, the messages exchanged are as follows:

M₂₂ addition acceptance message, addressed from the remote terminal of the user B to the front-end module 2;

M₂₃ contact modification message, addressed from the front-end module 2 to the user database 4, this modification message possibly comprising a confirmation request flag, with the value 0 for example;

M₂₄ message of notification of acceptance by the remote terminal of the user B to the user A of the local terminal, this message being addressed from the front-end module 2 to the notification module 3.

The notification procedure can be implemented in accordance with the protocol represented and described in conjunction with FIG. 4a.

Other messages may be envisaged, such as:

M₂₅ authorization request deletion message, transmitted from the notification module 3 to the user database 4;

M₂₆ response addition message, likewise transmitted from the notification module 3 to the user database 4.

On denial of the user B of the remote terminal, the addition of the electronic address of the aforesaid remote terminal being denied by the latter, the messages implemented hereinafter are as follows:

M₂₇ denial message, transmitted from the remote terminal of the user B to the front-end module 2;

M₂₈ message of deletion of the electronic address or contact of the user B from the list of counterparts or contacts of the user A, transmitted from the front-end module 2 to the user database 4;

M₂₉ message of notification of denial by the user B to the user A, this message being transmitted from the front-end module 2 to the notification module 3.

The notification procedure can then be conducted in accordance with the protocol represented in FIG. 4a.

The request deletion message, M₃₀, and response addition message, M₃₁, may correspond to the messages M₂₅ and M₂₆ described previously in conjunction with the same FIG. 4d.

A terminal furnished with an electronic access address specially adapted to the implementation of the method and of the system which are the subjects of the present invention, will now be described in conjunction with FIGS. 5a to 5d, then 5e to 5i.

The aforesaid terminal may of course play the role of local terminal, respectively of remote terminal for the implementation of the method and the system which are the subjects of the present invention as described previously in the description.

According to a noteworthy implementational aspect, each terminal comprises at least, stored in specific memory, a set of electronic addresses of each remote terminal, the relevant terminal playing the role of a local terminal, this set being compiled into at least one list of electronic addresses of counterparts of the user of this terminal.

In FIG. 5a and FIG. 5b is represented the aforesaid set of electronic addresses by the list LI previously described in the description in conjunction with FIGS. 1a, 1b, 1c and 1d.

Furthermore, the aforesaid specific memory comprises a plurality of distinct groups of electronic addresses, these distinct groups being compiled from the list of electronic addresses of counterparts of the user of this terminal. In FIGS. 5a and 5b, the aforesaid groups are represented by the groups G₁, G₂, G₃ and G₄, which correspond to the group G₁, . . . , Gⱼ, . . . , Gₚ represented in FIGS. 1a and 1c.

Furthermore, the specific memory comprises at least one specific privileged accessibility function, chosen from among a plurality of privileged accessibility functions, each privileged accessibility function exhibiting a different degree of accessibility from the degree of accessibility of the other accessibility functions of this plurality, so as to compile groups of electronic addresses of distinct privileged accessibility to the electronic address for access to this terminal. In FIGS. 5a and 5b, the groups of electronic addresses of distinct privileged accessibility to the electronic address for access to the terminal, local terminal, bear the references GA₁, GA₂, GA₃, GA₄, as in FIGS. 1a, 1b, for example.

Of course, and preferably, it is possible to store groups whose privileged accessibility functions correspond to the function ALL, ALL EXCEPT, AE, ONLY THEM, SE, and NOBODY, NOB, as represented in particular in FIGS. 1b and 1d described previously in the description.

Of course, the specific memory can also comprise a plurality of subsets of electronic addresses of remote terminals, each of the subsets being compiled as a subset of distinct interest, that is to say according to the subsets SLI₁, . . . , SLIₖ, . . . , SLIₖ, such as represented for example in FIG. 1c. The sets and subsets of electronic addresses of remote terminals, stored on the aforesaid specific memory, may be organized as directories and the distinct groups may be organized as subdirectories with which a specific accessibility function is associated, to each remote terminal electronic address there being allocated the specific privileged accessibility associated with the corresponding subdirectories, solely because this remote terminal electronic address belongs to the aforesaid subdirectories, as is represented in particular in FIGS. 1c and 1d previously described in the description.

FIG. 5a represents in a more specific manner the case where the terminal consists of a microcomputer, this microcomputer, although represented by a portable microcomputer, possibly of course being constituted by an office microcomputer. Under these conditions, the specific memory is the mass memory of this microcomputer, mass memory denoted HDD.

Conversely, when the terminal consists of a mobile radiotelephony terminal, as represented in FIG. 5b, this terminal comprises, stored for example in nonvolatile memory, as appropriate in work memory, the set of data structures, that is to say of electronic addresses of remote terminals compiled into lists and sublists representing the sets and subsets, respectively the aforesaid groups. It is understood in particular that these data structures may be downloaded to the remote terminal and stored in random access memory of RAM type when the latter exhibits sufficient capacity to cater for the storage, or conversely, preferably, into a nonvolatile memory, such as an EEPROM memory, reprogrammable memory more specifically allowing the implementation of the method, which is the subject of the present invention, by simply updating the accessibility modifications introduced by a local terminal at the level of the remote terminal constituted by the relevant mobile radiotelephony terminal.

In FIG. 5b, the switch SW represents, symbolically, the storing of the aforesaid data structures, either in the random access memory RAM, or in the nonvolatile memory.

Of course, as represented in FIG. 5b, the aforesaid mobile radiotelephony terminal is furnished with a display screen, even one of small dimensions, so as to provide for the displaying of the aforesaid directories and subdirectories groups, in accordance with FIGS. 2a to 2c described previously in the description. In order to provide for the aforesaid display, the mobile telephony terminal as represented in FIG. 5b furthermore comprises, stored in nonvolatile memory for example, a specific piece of graphical interfacing software, such as WAP software, allowing the displaying of the directories and subdirectories containing the sets, respectively the subsets or groups of electronic addresses of remote terminals.

The method and the system, which are the subjects of the present invention, as described previously, make it possible to provide very efficient management of the electronic addresses of local or remote terminals. Furthermore, they also make it possible to provide simultaneous management of any telephone call number of a terminal consisting of a mobile radiotelephony terminal furnished moreover with an electronic address for communication on an IP network.

This type of mobile radiotelephony terminal can correspond for example to a mobile radiotelephony terminal of GPRS type, this radiotelephony system representing a major evolution of the GSM system with the introduction of packet mode data transmission.

For this reason, the radiotelephony service GPRS defines a packet switching network architecture with management of mobility and with access by radio, by way of a simple call number. Under these conditions, the GPRS network and system may be seen as an entirely separate data network, which moreover has an existing radiotelephony network at its disposal.

The GPRS radiotelephony system allows data transmissions at bit rates ranging up to 20 kb/s, such a bit rate making it possible first and foremost to provide for frequent transfers of small data volumes spaced relatively apart in time.

Under these conditions, a mobile radiotelephony terminal interconnected to the GPRS system and network, has at its disposal a specific electronic address making it possible to access this terminal by way of the IP network, and also has at its disposal a telephone call number also making it possible to access this terminal through a simple telephone call.

In order to provide for the management, not only of the electronic address of any mobile radiotelephony terminal of this type, in accordance with the method which is the subject of the present invention as described previously in the description, but also of the telephone call number associated with the latter, and, eventually, to provide for a specific implementation of the method which is the subject of the present invention for any set of mobile telephony terminals of this type, each terminal, whether it consist of a mobile telephony terminal or not, can furthermore comprise, a list of the telephone call numbers of the remote terminals consisting of a mobile telephony terminal. In FIG. 5c, this list is supposedly stored in nonvolatile memory and is designated NI.

The list NI comprises at least the telephone call numbers of the mobile telephony terminals whose electronic address for access to the IP network belongs to the list of counterparts of the user of this terminal, which plays for example the role of local terminal.

Furthermore, the aforesaid terminal comprises a module for redirecting the telephone call emanating from one of the telephone call numbers belonging to the list of telephone call numbers, the list NI, either when the remote terminal comprises no electronic address for access to the IP network, or when the user of this remote terminal and this remote terminal are not entitled to implement the method which is the subject of the present invention as described previously in the description, or else when the user of this remote terminal and this remote terminal are entitled to implement the method of management previously described in the description, but the user of this terminal, playing the role of local terminal, has declared himself unavailable according to a mode of unavailability or of qualified unavailability in relation to the user of this remote terminal.

A specific nonlimiting mode of implementation of the redirecting of the telephone call from a terminal consisting of a mobile radiotelephony terminal furnished, or otherwise, with an electronic address, will now be described in conjunction with FIG. 5d, with reference to the aforesaid FIG. 5c.

For the implementation of such an operational mode, it may be convenient, as represented in FIG. 5c, to establish lists of electronic addresses, lists LI, respectively of telephone call numbers, lists NI, comprising one and the same number of elements.

When the telephone call number of the remote terminal comprises no electronic address allowing IP network type access, to the location corresponding to the location of the telephone call number of this same terminal, is allocated, in the list of electronic addresses, the list LI, an arbitrary electronic address value, of course distinct from a real electronic address. This arbitrary value is denoted XXX in FIG. 5c.

Conversely, when the remote terminal consisting of a mobile radiotelephony terminal comprises an electronic address for IP type access, the value of this electronic address is of course introduced into the list LI. The corresponding telephone call number is also introduced at the same location as that of the electronic address in the list LI, so that a one-to-one correspondence is made between the electronic address of a mobile radiotelephony terminal and the telephone call number of this terminal, respectively between the arbitrary value XXX and the telephone call number of a terminal not furnished with an IP type electronic access address.

The implementation of the redirection protocol can then be effected, in a nonlimiting manner, in accordance with FIG. 5d, in the following manner:

A starting situation is assumed in which a user B, using for example a mobile radiotelephony terminal whose telephone call number is NB, calls another terminal of a user A whose telephone call number is NA, and of course the electronic address ADa. Under the starting assumption S, no assumption is made regarding the existence or the nonexistence of an electronic address for the terminal of the calling user B.

On receipt of the telephone call of the user B, and of course of the number of the calling user NB, at the level of the terminal A, a test T₁ can be carried out, consisting in verifying that the telephone call number NB belongs to the list NI.

Upon a negative response to the test T₁, the terminal of the user B not a priori forming part of the list of counterparts of the user A of the relevant terminal, an operation of call redirection to a specific call number can be carried out, in step R. In this redirection operation R, the calling user B finds himself diverted to the specific call number, which may for example be the secretary of the user A or any appropriate service.

Conversely, upon a positive response to the test T₁, the telephone call number NB of the user B belonging to the list NI, and therefore being party to the counterparts of the user A, the aforesaid test T₁ makes it possible, in a conventional manner, to determine the rank k of the telephone call number NB of the calling user B.

The discrimination of the rank k of the latter in the list NI makes it possible of course, by virtue of the one-to-one correspondence between electronic address and telephone call number of the lists NI and LI, to read the assumed electronic address ADₖ allocated to the terminal of the calling user. This reading step is denoted L in FIG. 5d.

Step L is then followed by a test step T₂ which consists in comparing, by comparison of equality, the assumed electronic address ADₖ with the arbitrary address value XXX assigned when the terminal of the calling user B has no electronic address.

Upon a positive response to the test T₂, the terminal of the user B having no electronic address, a call to the step R of call redirection to a specific call number may be implemented so as to provide efficient management of the telephone call of the user B.

Upon a negative response to the test T₂, the terminal of the user B benefiting a priori from an IP type electronic address, a test T₃ is carried out so as to verify the existence of a mode of availability corresponding, either to strict unavailability, or to qualified unavailability, of the terminal of the user A with address ADₐ for the terminal with address ADₖ of the user B.

Upon a positive response to the test T₃, the terminal of the user A and the user A having declared themselves unavailable, either through strict unavailability, or through qualified unavailability in relation to the user B and to the latter's terminal with electronic address ADₖ, a call to the step of call redirection to a specific call number can be executed;

conversely, upon a negative response to the test T₃, the terminal of the user A and the latter having declared themselves available in relation to the terminal and to the user B, the method which is the subject of the present invention can be continued in accordance with the description previously given.

Various screen pages displayable on a terminal, allowing the implementation of the method and of the system which are the subjects of the present invention, will now be described in conjunction with FIGS. 5e to 5i.

FIG. 5e represents, by way of illustration, a general screen page for customization of the software allowing the implementation of the method which is the subject of the present invention.

The aforesaid screen page comprises in particular a field for selecting the mode of warning of the user of the terminal when a friend, defined as the user of the terminal whose electronic address is registered in the directory Friends, as described previously in the description, logs on or logs off, the warning possibly being effected with a sound or with a written message. The aforesaid screen page also comprises a field of choices of all the counterparts or some of them. The aforesaid choices may of course be made, in a conventional manner, on the basis of a pointing system, such as a mouse or the like.

FIG. 5f depicts a screen page making it possible to initialize the type of connection to the network used and, in the case of FIG. 5f, to the INTERNET network.

The aforesaid screen page can comprise various fields specifying the direct UMTS connection or, conversely, connection by way of a “proxy”, as well as the designation of the name of the server used and the number of the corresponding port. Other fields may be used.

FIG. 5g represents, by way of illustration, a screen page for implementing the method which is the subject of the present invention. As represented in the aforesaid figure, this screen page comprises a warning according to which a friend is connected, corresponding to a written warning, a field for displaying the directories and subdirectories in accordance with the method which is the subject of the present invention, directories such as Friend, Family, Office, Future contacts, Strangers or the like, and corresponding to subsets of distinct interest to the user.

Finally, specific icons make it possible to call up other screen pages for creating directories, or creating folders, deleting folders, searching for a contact, for example.

FIG. 5h represents a screen page designated Profile, making it possible in fact to compile public, respectively private, identity cards integrated into the terminal of the user. This screen page makes it possible to input fields relating to the identity of the user, his age, his sex, his personal address, in relation to centers of Interest, or one or more electronic email addresses in particular.

FIG. 5i represents, by way of nonlimiting example, a specific mode of display of the accessibility or of the nonaccessibility of the user terminal by various electronic addresses of the directory Friend. It is noted in particular that, in a specific nonlimiting manner, accessibility is represented by an icon with a smiling expression, whereas nonaccessibility is conversely represented by an icon with a grumpy expression.

By way of nonlimiting example, the privileged accessibility function adopted highlighted and corresponding to the function ONLY THEM SE in FIG. 5i, may furthermore be represented by a pie chart, part of which is lit up, portraying the ONLY THEM function, and the remainder of which is unlit.

There has thus been described a method and a system for managing the accessibility of the electronic address of a local terminal of a user by one or more remote terminals, which are especially powerful insofar as the method and the system, which are the subjects of the invention, allow efficient and controlled management of the accessibility by any remote terminal as a function of the availabilities of the user of any local terminal in relation to these remote terminals.

In particular, and within the framework of the implementation of the method which is the subject of the present invention, it is indicated that the procedure for authorizing registration of a new remote terminal makes it possible to efficiently control any risk of inopportune access to the corresponding local terminal.

Finally, the method and the system, which are the subjects of the present invention, make it possible to manage the accessibility of the electronic address of a local terminal consisting of any type of terminal, and in particular the latest-generation mobile radiotelephony terminals which allow, not only access by way of an IP address, but also by way of any telephone call number.

1. A method of managing the accessibility of the electronic address of a local terminal of a user by one or more remote terminals each furnished with an electronic address, characterized in that it consists:
in compiling the set of electronic addresses of each remote terminal into at least one list of electronic addresses-of counterparts of this user;
in subdividing the set of electronic addresses into distinct groups of electronic addresses;
in allocating each distinct group of electronic addresses a specific privileged accessibility function chosen from among a plurality of privileged accessibility functions, each privileged accessibility function exhibiting a different degree of accessibility from the degree of accessibility of the other accessibility functions of this plurality of privileged accessibility functions, so as to compile groups of electronic addresses of distinct privileged accessibility.

2. The method as claimed in claim 1, characterized in that said groups of electronic addresses of distinct privileged accessibility comprise at least:
an ALL group for which restrictionless unreserved accessibility to said local electronic address is allocated, by way of a first accessibility function, to all the electronic addresses belonging to this group;
an ALL EXCEPT group for which restrictionless unreserved accessibility to said local electronic address is allocated, by way of a second accessibility function, to all the electronic addresses not belonging to this group;
an ONLY THEM group for which restrictionless unreserved accessibility to said local electronic address is allocated, by way of a third accessibility function, to all the electronic addresses belonging to this group;
a NOBODY group for which no accessibility to said local electronic address is allocated, by way of a fourth accessibility function, to all the electronic addresses belonging to this group.

3. The method as claimed in one of claims 1 or 2, characterized in that it consists furthermore in compiling the set of said electronic addresses of each remote terminal into subsets of distinct interest to the user, each subset consisting of a sublist.

4. The method as claimed in one of claims 1 to 3, characterized in that said functions of specific privileged accessibility, and said groups of electronic addresses of distinct privileged accessibility are pairwise complemented.

5. The method as claimed in one of claims 1 to 4, characterized in that, with each list or sublist of electronic addresses is associated a directory and with each distinct group of electronic addresses is associated a subdirectory, with each subdirectory there being associated a specific accessibility function, to each remote terminal electronic address there being allocated the specific privileged accessibility associated with said subdirectory solely because this remote terminal electronic address belongs to said directory respectively subdirectory.

6. The method as claimed in one of claims 1 to 5, characterized in that, with each privileged accessibility group is further associated a mode of availability of the user of said local terminal, said mode of availability comprising various degrees of availability displayed for the attention of any user of a remote terminal, the various degrees of availability comprising at least availability, unavailability, qualified unavailability.

7. The method as claimed in one of claims 1 to 6, characterized in that, with each remote or local terminal electronic address is associated a set of specific attributes representative of this remote or local terminal and of its user.

8. The method as claimed in claim 7, characterized in that the specific attributes representative of the user of a terminal comprise at least:
a public electronic identity card, accessible from all the electronic addresses of a remote terminal;
a private electronic identity card accessible from only those electronic addresses of a remote terminal belonging to at least one subset of distinct interest to the user.

9. The method as claimed in claim 7 or 8, characterized in that said specific attributes representative of a terminal comprise at least:
a terminal class attribute chosen from among a group of classes of terminal and of their operating system, classes of terminal such as microcomputer, digital assistant, mobile telephony terminal equipped with a display screen;
a communication service level attribute comprising, for each class of terminal, parameters regarding display respectively interfacing of navigation.

10. A system for managing the accessibility of the electronic address of the local terminal of a user by one more remote terminals each furnished with an electronic address, characterized in that it comprises a specific interactive server networked with said terminals, said interactive server comprising at least:
a front-end access module allowing interactive logon of any local terminal so as to effect on the initiative of the user of this local terminal a dynamic allocation, to at least one group of electronic addresses of several remote terminals, of a privileged accessibility function and to compile at least one group of electronic addresses of privileged accessibility to the electronic address of said local terminal;
a module for notification, to any remote terminal whose electronic address belongs to the set of electronic addresses constituting a list of electronic addresses of counterparts of this user and of the local terminal of the latter, of messages for notification and for updating of the current accessibility of the electronic address of said local terminal by each remote terminal.

11. The system as claimed in claim 10, characterized in that said front-end access module further comprises, for any access from a local terminal:
a module for creating distinct groups of electronic addresses and for allocating a privileged accessibility function to each distinct group; and
a module for changing state of the accessibility of the electronic address of said local terminal by at least one group of electronic addresses of privileged accessibility.

12. A terminal furnished with an electronic access address, connected to an electronic network to which remote terminals each furnished with an electronic address are connected, characterized in that said terminal comprises at least, stored in specific memory:
a set of electronic addresses of each remote terminal compiled into at least one list of electronic addresses of counterparts of the user of this terminal;
a plurality of distinct groups of electronic addresses, these distinct groups being compiled from said at least one list of electronic addresses of counterparts of the user of this terminal;
at least one specific privileged accessibility function chosen from among a plurality of privileged accessibility functions, each privileged accessibility function exhibiting a different degree of accessibility from the degree of accessibility of the other accessibility functions of this plurality of privileged accessibility functions, so as to compile groups of electronic addresses of distinct privileged accessibility to the electronic access address of this terminal.

13. The terminal as claimed in claim 12, characterized in that said groups of electronic addresses of distinct accessibility to the electronic address for access to this terminal comprise at least:
an ALL group for which restrictionless unreserved accessibility to the electronic access address of said terminal is allocated, by way of a first accessibility function, to all the electronic addresses belonging to this group;
an ALL EXCEPT group for which restrictionless unreserved accessibility to the electronic access address of said terminal is allocated, by way of a second accessibility function, to all the electronic addresses not belonging to this group;
an ONLY THEM group for which restrictionless unreserved accessibility to the electronic access address of said terminal is allocated, by way of a third accessibility function, to all the electronic addresses belonging to this group;
a NOBODY group for which no accessibility to the electronic access address of said terminal is allocated, by way of a fourth accessibility function, to all the electronic addresses belonging to this group.

14. The terminal as claimed in claim 12 or 13, characterized in that it furthermore comprises, stored in specific memory, a plurality of subsets of electronic addresses of remote terminals, each subset being compiled as a subset of distinct interest to the user and formed by a sublist of said at least one list of electronic addresses of counterparts of the user of this terminal.

15. The terminal as claimed in one of claims 12 to 14, characterized in that the sets and subsets of electronic addresses of remote terminals are organized into directories and in that the distinct groups are organized into subdirectories, with each subdirectory there being associated a specific accessibility function, to each remote terminal electronic address there being allocated the specific privileged accessibility associated with said subdirectory solely because this remote terminal electronic address belongs to said subdirectory.

16. The terminal as claimed in one of claims 12 to 15, characterized in that, this terminal consisting of a microcomputer, the specific memory is the mass memory of this microcomputer.

17. The terminal as claimed in one of claims 12 to 15, characterized in that, this terminal consisting of a digital assistant or a mobile telephony terminal equipped with a display screen, said specific memory is the nonvolatile memory of said terminal.

18. The terminal as claimed in claim 17, characterized in that, said terminal consisting of a mobile telephony terminal, the latter further comprises, stored in nonvolatile memory of this terminal, a specific piece of software for graphical interfacing allowing the displaying of said directories and subdirectories containing said sets, respectively subsets or groups of electronic addresses of remote terminals.

19. The terminal as claimed in one of claims 12 to 15, characterized in that this terminal consisting of a mobile telephony terminal, the latter furthermore comprises:
a list of the telephone call numbers of the remote terminals consisting of a mobile telephony terminal, this list of the call numbers comprising at least the telephone call numbers of the mobile telephony terminals whose electronic address for access to the IP network belongs to the list of counterparts of the user of this terminal, playing the role of local terminal; and
means of redirection of the telephone call emanating from one of the telephone call numbers belonging to said list of telephone call numbers, either when the remote terminal comprises no electronic address for access to the IP network, or when the user of this remote terminal and this remote terminal are not entitled to implement the method as claimed in one of claims 1 to 9, or else when the user of this remote terminal and this remote terminal are entitled to implement the method of management as claimed in one of claims 1 to 9 but the user of this terminal, playing the role of local terminal, has declared himself unavailable according to a mode of unavailability or of qualified unavailability in relation to the user of this remote terminal.
